(19) United States
(12) Patent Application Publication
(10) Pub. No.: US 2026/0088713 A1
(43) Pub. Date: Mar. 26, 2026

(54) TAIL REGULATED SWITCHED CAPACITOR CONVERTERS

(71) Applicant: Apple Inc., Cupertino, CA (US)

(72) Inventors: Zhiyuan Hu, Santa Clara, CA (US); Stephen C. Terry, San Jose, CA (US); Guangqi Zhu, Santa Clara, CA (US); Jukka-pekka J. Sjoeroos, Cupertino, CA (US); Jizhen Fu, San Jose, CA (US)

(21) Appl. No.: 18/897,556

(22) Filed: Sep. 26, 2024

(51) Int. Cl. H02M 3/07

(52) U.S. Cl. CPC H02M 3/07

(57) ABSTRACT

A tail regulated switched capacitor converter can include a plurality of switched capacitor stages each having a flying capacitor and a plurality of switching devices. The plurality of switching devices can include a first group of one or more switches that selectively couple the flying capacitor to one of an input or output voltage rail via a first current path and a second group of one or more switches that selectively couple the flying capacitor to a tail voltage rail via a second current path. The first and second groups of one or more switches can be switched complementarily to one another with a 50% duty cycle. The tail regulated switched capacitor converter can further include a regulated converter coupled to the tail voltage rail that provides voltage regulation of the output voltage rail while carrying half of a full output current of the tail regulated switched capacitor converter.

### BACKGROUND

Switched capacitor converters, including one or more switched or “flying” capacitors and associated switching devices to selectively connect the flying capacitors in different configurations between the converter input and the converter output, can operate with high efficiency as compared to inductor-based voltage regulators. However, switched capacitor converters typically offer only a fixed voltage conversion ratio, meaning that the output voltage is an integer multiple of the input voltage for step-up switched capacitor converters or an integer fraction of the input voltage for step-down switched capacitor converters. In many applications, it may be desirable to provide voltage regulation, in which a specified output voltage value can be maintained for any input voltage within a relatively wide operating range.

To address this issue, regulated converters have been cascaded upstream or downstream of a switched capacitor converter. However, this approach can result in lower efficiency due to the increased number of power stages.

### SUMMARY

Thus, it may be desirable to provide improved switched capacitor converters that can achieve the higher operating efficiencies that may be associated with switched capacitor converters while also providing voltage regulation.

A tail regulated switched capacitor converter can include a plurality of switched capacitor stages each having a flying capacitor and a plurality of switching devices. The plurality of switching devices can include a first group of one or more switches that selectively couple the flying capacitor to one of an input or output voltage rail via a first current path and a second group of one or more switches that selectively couple the flying capacitor to a tail voltage rail via a second current path. The first and second groups of one or more switches can be switched complementarily to one another with a 50% duty cycle. The tail regulated switched capacitor converter can further include a regulated converter coupled to the tail voltage rail that provides voltage regulation of the output voltage rail while carrying half of a full output current of the tail regulated switched capacitor converter.

The tail regulated switched capacitor converter can be a step-down converter. The first group of one or more switches can selectively couple the flying capacitor to the output voltage rail via the first current path. The regulated converter can have its input connected to the tail voltage rail and its output connected to the output voltage rail. The regulated converter can be a buck converter or a boost converter.

The tail regulated switched capacitor converter can be a step-up converter. The first group of one or more switches can selectively couple the flying capacitor to the input voltage rail via the first current path. The regulated converter can have its input connected to the input voltage rail and its output connected to the tail voltage rail. The regulated converter can be a buck converter or a boost converter.

The tail regulated switched capacitor converter can be a Dickson type switched capacitor converter or a series-parallel type switched capacitor converter.

A tail regulated switched capacitor converter can include a plurality of switched capacitor stages each having a flying capacitor and a plurality of switching devices that selectively couple the flying capacitor to one of an input or output voltage rail via a first current path and selectively couple the flying capacitor to a tail voltage rail via a second current path; and a regulated converter coupled to the tail voltage rail, wherein the regulated converter carries less than a full output current of the tail regulated switched capacitor converter and provides voltage regulation of the output voltage rail. The tail regulated switched capacitor converter is a Dickson type switched capacitor converter or a series-parallel type switched capacitor converter. The tail regulated switched capacitor converter can further include an output capacitor supporting the output voltage rail and a tail output capacitor supporting the tail voltage rail.

The tail regulated switched capacitor converter can be a step-down converter. The plurality of switching devices can selectively couple the flying capacitor to the output voltage rail via the first current path. The regulated converter can have its input connected to the tail voltage rail and its output connected to the output voltage rail.

The tail regulated switched capacitor converter can be a step-up converter. The plurality of switching devices can selectively couple the flying capacitor to the input voltage rail via the first current path. The regulated converter can have its input connected to the input voltage rail and its output connected to the tail voltage rail.

The regulated converter can be a buck converter or a boost converter.

A tail regulated switched capacitor converter can include a plurality of switched capacitor stages each having a flying capacitor; and a plurality of switching devices including a first group of one or more switches that selectively couple the flying capacitor to one of an input voltage rail or an output voltage rail via a first current path and a second group of one or more switches that selectively couple the flying capacitor to the tail voltage rail via a second current path; and a regulated converter coupled to the tail voltage rail that provides voltage regulation of the output voltage rail while carrying less than a full output current of the tail regulated switched capacitor converter. The plurality of switched capacitor stages can include more than two switched capacitor stages. The tail regulated switched capacitor converter can further include an output capacitor supporting the output voltage rail and a tail output capacitor supporting the tail voltage rail.

### BRIEF DESCRIPTION OF THE DRAWINGS

FIG. 1 illustrates block diagrams of switched capacitor converters with cascaded regulation stages.

FIG. 2 illustrates schematic diagrams of a Dickson type switched capacitor converter and a series-parallel type switched capacitor converter.

FIG. 3 illustrates schematic diagrams of a Dickson type tail-regulated switched capacitor converter and a series-parallel type tail regulated switched capacitor converter.

FIG. 4 illustrates a schematic diagram of a Dickson type tail-regulated switched capacitor converter with a buck regulated tail stage.

FIG. 5 illustrates a schematic diagram of a Dickson type tail-regulated switched capacitor converter with a boost regulated tail stage.

FIG. 6 illustrates schematic diagrams of a voltage step-up Dickson type tail-regulated switched capacitor converter and a voltage step-up series-parallel type tail regulated switched capacitor converter.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

Described herein is a family of regulated switched capacitor converter topologies. The regulation mechanism is described as “tail regulation,” because the regulation circuit can be located after the lowest voltage flying capacitor stage of a step-down switched capacitor converter, as described in greater detail below. However, in some embodiments, the regulation circuit can be located ahead of the lowest-voltage flying capacitor stage for a step-up switched capacitor converter. These configurations, too, are referred to as “tail regulated,” although the tail is at the input side of the switched capacitor converter, rather than the output.

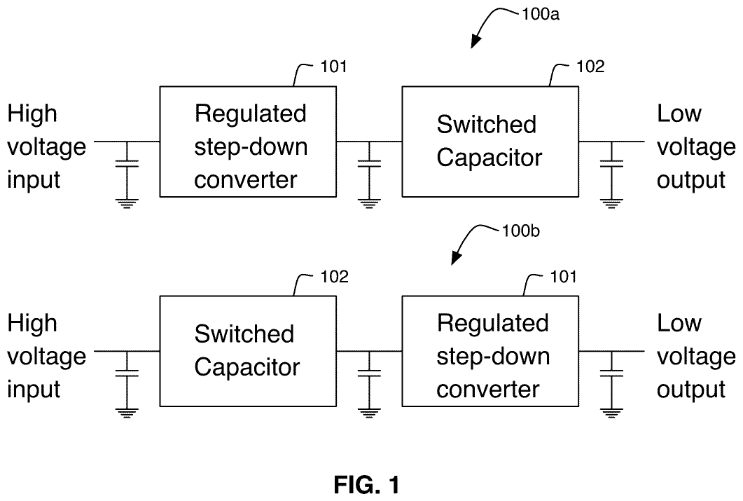

As described above, conventional switched capacitor converters can achieve high efficiency but offer no voltage regulation. One can add regulation stages cascaded with a switched capacitor converter, which may sacrifice operating efficiency. FIG. 1 illustrates block diagrams of switched capacitor converters with cascaded regulation stages. In block diagram 100a, an input voltage, e.g., a high voltage input (relative to the output voltage) can be provided to a regulated converter 101. Regulated converter 101 can be any of a variety of converter types, such as a buck converter, multi-level buck converter, etc. if a step-down of the input voltage is desired. In other cases, for example if a range of input voltages is expected, then a step-up regulated converter, such as a boost converter, or a converter capable of step-up or step-down operation, such as a buck-boost converter could also be provided. In any case, the regulated converter 101 can provide a regulated output voltage that can be provided as the input to switched capacitor converter 102. Switched capacitor converter 102 can produce an output voltage (e.g., low voltage output) that is an integer multiple or integer fraction of the regulated voltage it receives at its input, with the fraction being determined by the number of switched or flying capacitors in switched capacitor converter 102.

The above-described configuration can also be reversed, as illustrated in block diagram 100b. In this case, the input voltage is applied to the switched capacitor stage 102, which then provides a voltage that is an integer multiple or integer fraction of the input voltage to a regulated converter 101, which, again, can provide a higher or lower output voltage, as required for a particular application. In either case, the additional regulated converter stage cascaded with the switched capacitor converter incurs additional power losses. Additionally, both converter stages (i.e., the regulated converter and the switched capacitor converter) must be designed to handle full power, which can result in significant cost and size increases.

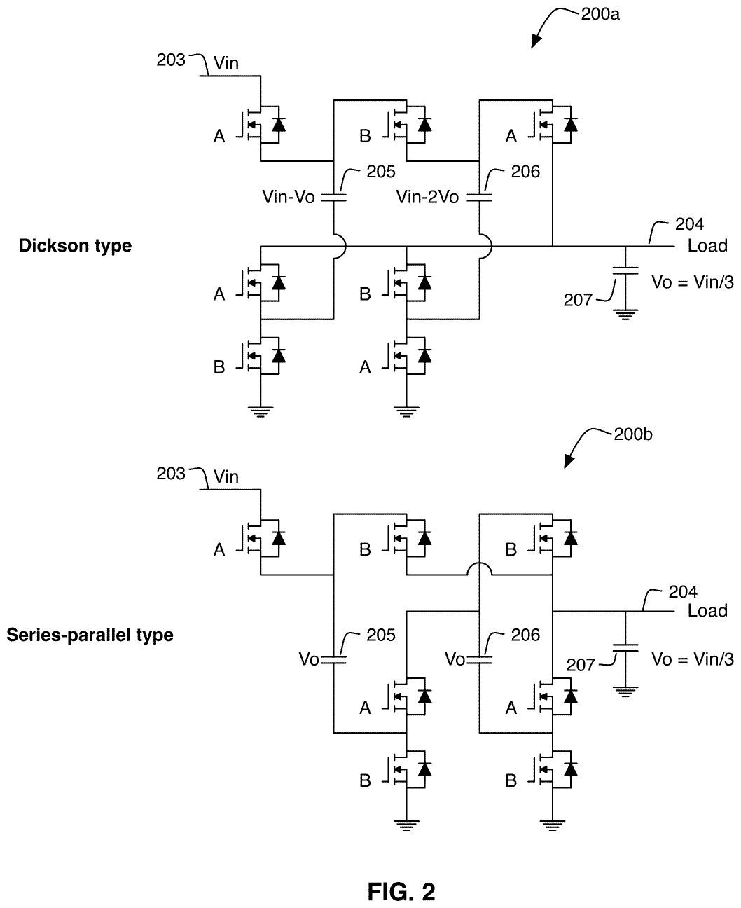

Two types of switched capacitor converters include the Dickson type switched capacitor converter and the series-parallel type switched capacitor converter. FIG. 2 illustrates schematic diagrams of a Dickson type switched capacitor converter 200a and a series-parallel type switched capacitor converter 200b. Dickson type switched capacitor converter 200a includes two switched or flying capacitors 205, 206 and associated switching devices; however, additional stages could be provided. The switching devices are illustrated as metal oxide semiconductor field effect transistors (MOSFETs), but other switching device types could be used if desired. The switching devices may be implemented using any suitable semiconductor technology, such as silicon (Si), silicon carbide (SiC), gallium nitride (GaN), etc. The switching devices can be divided into two groups, which are operated complementarily, i.e., when switches of group A are turned on, switches of group B are turned off and vice-versa. These operations can be performed by control circuitry (not shown) that uses a reference clock to perform the switching operations at a desired rate. In at least some applications, the switching device groups may be operated with a 50% duty cycles, such that the respective on and off times of each group are equal.

The switched capacitor converter can receive an input voltage Vin at an input voltage rail 203 of the switched capacitor converter and can produce an output voltage Vo to a load connected to output bus 204 of the switched capacitor converter. Operation of the converter can be summarized as follows: when switch group A is closed, and switch group B is opened, current can flow from input voltage rail 203, through first flying capacitor 205, through the next switch A to the output bus 204. As a result, the nominal voltage across flying capacitor 205 will be Vin−Vo. When switch group B is closed, and switch group A is opened, the Vin−Vo voltage across first flying capacitor 205 will be applied to output bus 204 via second flying capacitor 206, resulting in a nominal voltage of Vin−2Vo appearing across second flying capacitor 206. Both flying capacitor voltages are nominal, in that they will experience a ripple varying around these nominal values as the capacitors charge and discharge, transferring power from input voltage rail 203 to output bus 204, with the net result that the nominal voltage appearing at the output (i.e., across output capacitor 207) is ⅓ the input voltage (for a two-stage switched capacitor converter). In other words, with two flying capacitor stages, the nominal output voltage Vo will be ⅓ the input voltage Vin, with some ripple that will vary depending on the operating load, capacitor values, switching frequency, etc. Stated more generally, the output voltage will be 1/(n+1) times the input voltage, where n is the number of switched capacitor stages, and the nominal voltage across each flying capacitor will be the input voltage minus m times the output voltage, where m is the sequential number of the flying capacitor stage as counted from the input side, i.e., 1^{st}, 2^{nd}, 3^{rd}, etc.

Series-parallel switched capacitor converter 200b can have a similar combination of flying capacitor stages, including flying capacitors 205, 206 and associated switching devices. As above, the switching devices can be divided into two groups A, B that are switched complementarily by control circuitry (not shown). Because of the configuration of series-parallel switched capacitor converter 200b, flying capacitors 205, 206 charge in series and discharge in parallel. That is, when switch group A is closed, current will flow from input voltage rail 203 via first and second flying capacitors connected in series by other switches of group A and connected to the output bus 204. Then, when switch group B is closed, flying capacitors 205 and 206 are connected in parallel to output bus 204. The result is that the nominal voltage across the flying capacitors is the output voltage Vo, which is also ⅓ of the input voltage (for a two-stage switched capacitor converter). Stated more generally, the output voltage will be 1/(n+1) times the input voltage, where n is the number of switched capacitor stages, and the nominal voltage across each flying capacitor will be equal to the output voltage.

The above-described switched capacitor converters 200a, 200b are step-down converters, meaning that the input voltage Vin is stepped-down to an output voltage Vo that is an integer fraction of the input voltage Vin, with the integer being n+1, where n is the number of switched capacitor stages. It is also possible for either type of switched capacitor converter to be operated in the reverse direction, i.e., with input and output reversed, such that the output voltage is an integer multiple of the input voltage, with the integer being n+1, where n is the number of switched capacitor stages.

Further details of the construction and operation of switched capacitor converters are known to those skilled in the art and are not repeated herein for sake of brevity. For purposes of the present disclosure, switched converter operation can be summarized as follows. In both types of converter (i.e., Dickson and series-parallel types), each flying capacitor has two current paths. Current flows into the capacitor via one path and flows out of the capacitor via the other path. The two paths merge after the most down-stream flying capacitor, with both current paths flowing into the output capacitor. Because the most down-stream flying capacitor periodically couples to the output capacitor, the output voltage must equal to the most down-stream flying capacitor voltage, and hence cannot be independently regulated.

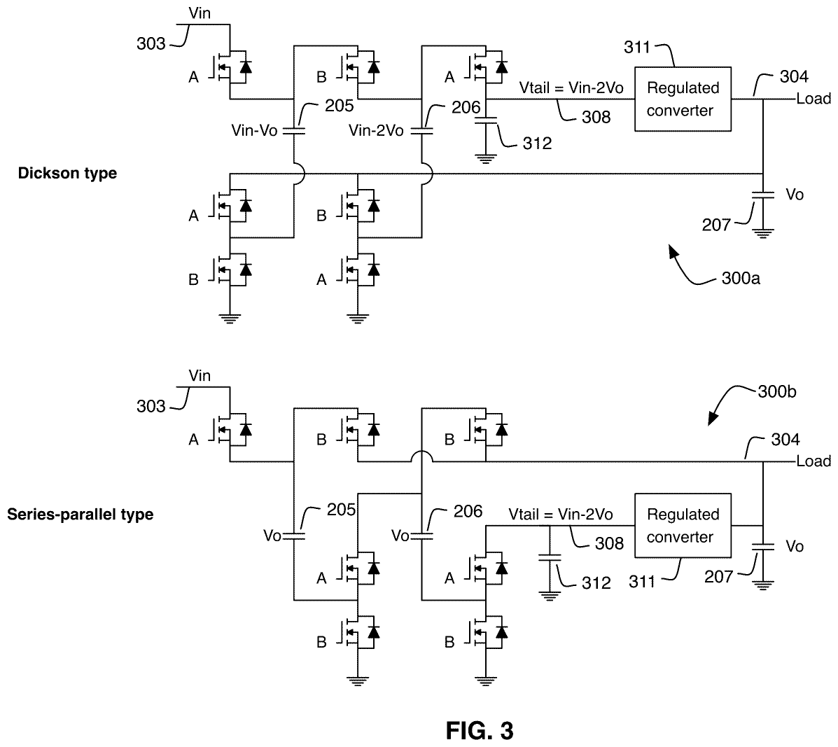

FIG. 3 illustrates schematic diagrams of a Dickson type tail-regulated switched capacitor converter 300a and a series-parallel type tail regulated switched capacitor converter 300b. Each Tail Regulated Switched Capacitor (TRSC) converter can have an input rail 303 corresponding to input voltage rail 203 described above. Each TRSC converter can also have two separate output rails and associated output capacitors for the respective input and the output current paths of the most down-stream flying capacitor. That is, each switched capacitor converter can have the “regular” output capacitor 207 and associated output voltage rail 304 as described above. Additionally, each switched capacitor converter can have the “tail” voltage rail 308, which can have an associated “tail” output capacitor 312. The switching devices of either converter type can be operated as described above. As a result, for both the Dickson and series-parallel type TRSC converters, there can be an output capacitor 207 supporting an output rail 304 and providing an output voltage Vo. There can also be a tail voltage rail 308, supported by associated tail capacitor 312 that can be connected as an input into a regulated power stage 311.

For the illustrated converters with two switched or flying capacitors 205, 206, the tail rail will have a nominal voltage Vtail equal to Vin−2Vo, though this value will vary with different numbers of switched or flying capacitor stages, and TRSC converters with any number of switched or flying capacitor stages may be provided. In other cases, the voltage of the tail rail for a step-down converter will be the input voltage minus n times the output voltage, where n is the number of switched capacitor stages. The regulated power stage 311 can be any appropriate regulated converter type, such as a buck converter, a multi-level buck converter, a boost converter, a buck-boost converter, etc. These and other regulated converter topologies are known to those skilled in the art; thus, their details are not repeated here for sake of brevity. However, a significant aspect of this configuration is that regulated converter 311, i.e., “tail stage” converter, need only deal with a fraction of the output current. In the illustrated example, this is ½ the output current. As a result, the conduction losses associated with such a converter will be correspondingly reduced, and the illustrated regulated converters 311 can have ¼ the conduction losses (I²R) of a regulated converter cascaded that receives the full output current, as described above with reference to FIG. 1. Additionally, in the illustrated step-down configurations, regulated converter 311 also need only deal with a fraction of the input voltage. Some regulated converters, e.g., buck converters, can have an operating efficiency that increases in response to a smaller difference between input voltage and decreases in response to a larger difference between input voltage and output voltage. This can result in further improved efficiency, as the regulated converter is also dealing with a lower input voltage.

Notwithstanding the above, the tail stage regulated converter 311 can still effectively regulate the output voltage of the entire TRSC converter. This regulation through the tail stage can be understood as follows: when load increases, the tail stage converter 311 will increase its output current. Its input current will also increase accordingly, hence bringing down its input voltage (Vtail). A reduced tail rail voltage Vtail will correspondingly increase the ripple voltages on all flying capacitors 205, 206, thereby increasing both the input and output current of all flying capacitors. This phenomenon can be also understood from a capacitor charge-balance angle. All the flying capacitors 205, 206 must have equal input and output current to maintain a stable voltage. Therefore, the cascaded flying capacitor stages naturally have equal input current which in turn equals to the input current of the regulated tail stage. Therefore, the tail stage's input current naturally equals to the input current from the Vin source.

A potential advantage of TRSC converters can be that a majority of the input power can be delivered to the output by the flying capacitors (e.g., 205, 206), thus achieving the higher operating efficiencies typically associated with switched capacitor converters. Moreover, although the tail stage regulator 311 may have lower efficiency, because it is only processing a fraction of the total power, the result of its decreased efficiency on the total TSRC converter efficiency is reduced. Thus, a properly designed TRSC converter can achieve higher efficiency than that is possible with a two-stage architecture as described above with respect to FIG. 1.

As with all switched capacitor topologies, TRSC converters may require a relatively high number flying capacitors/flying capacitor stages to achieve high efficiency. This can result in a relatively large solution size. However, the capacitance requirement can be reduced by (1) increasing switching frequency, and/or (2) introducing resonance of the switched capacitors with parasitic or discrete inductances. Additionally, with a fixed number of flying capacitor stages, a TRSC converter may be able to support only a relatively narrow Vin range. To support an extended Vin range, the converter needs to re-configure the operating flying capacitor stages, e.g., by turning certain switching devices to always on or always off to selectively engage or bypass additional converter stages, which can result in non-smooth transitions between numbers of operating stages.

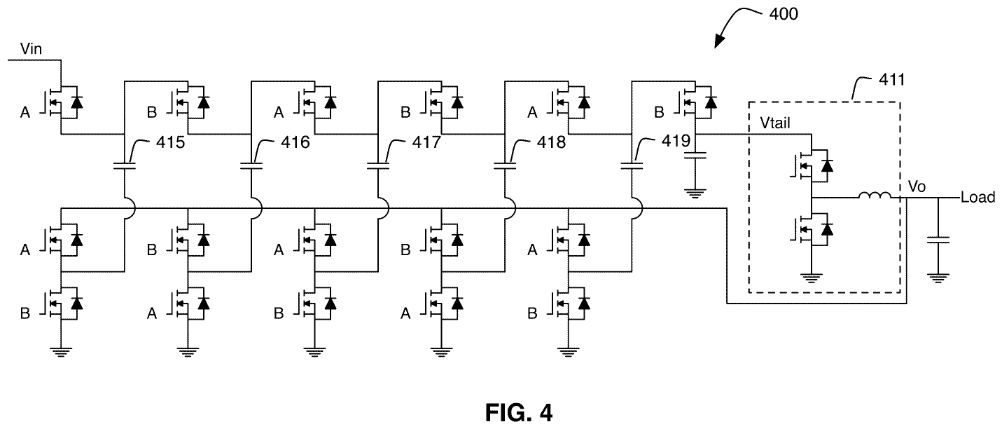

FIG. 4 illustrates a schematic diagram of a Dickson type tail-regulated switched capacitor (TRSC) converter 400 with a buck regulated tail stage 411. The illustrated converter 400 includes five switched or flying capacitor stages 415, 416, 417, 418, and 419.

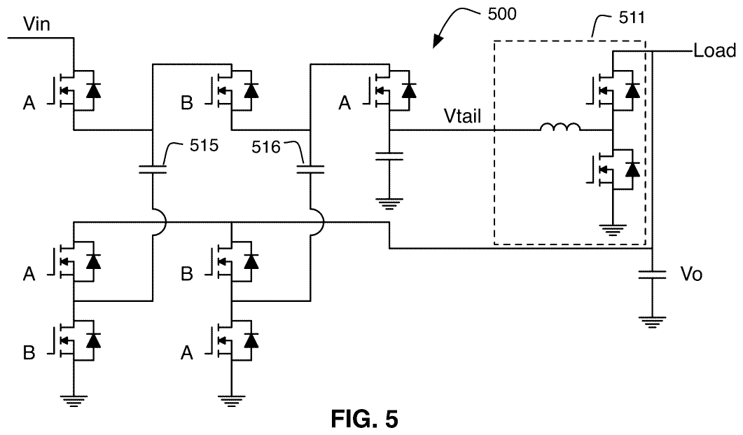

FIG. 5 illustrates a schematic diagram of a Dickson type tail-regulated switched capacitor converter 500 with a boost regulated tail stage 511. The illustrated converter 500 includes two switched or flying capacitor stages 515, 516.

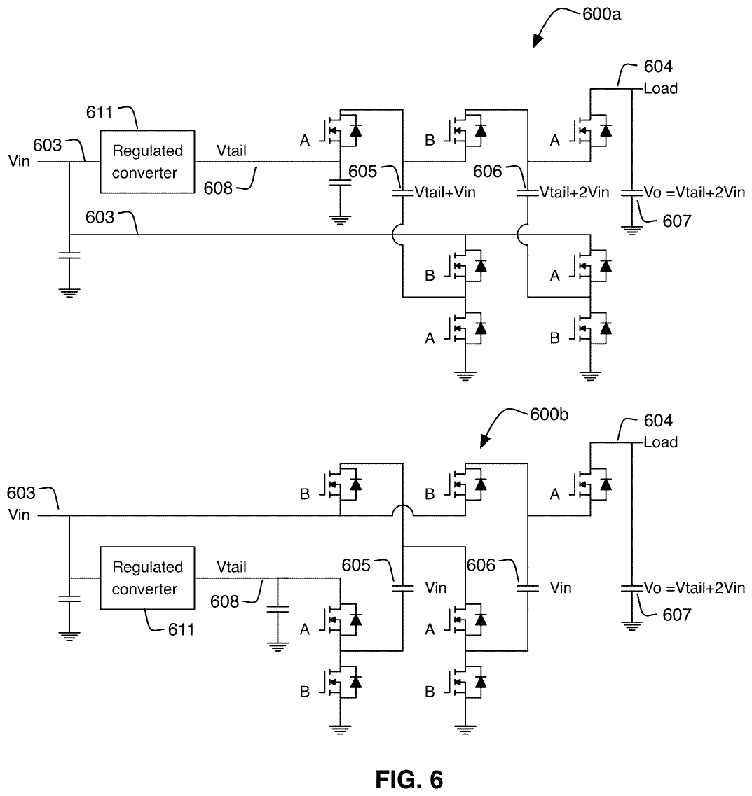

FIG. 6 illustrates schematic diagrams of a voltage step-up Dickson type tail-regulated switched capacitor (TRSC) converter 600a and a voltage step-up series-parallel type tail regulated switched capacitor converter 600b. As mentioned above, switched capacitor converters can be operated in either direction to either step up or step down an input voltage. Thus, converters 600a and 600b can be considered as operating in reverse as compared to converters 300a and 300b described above. That is, input rail 603 corresponds structurally to output rail 304 described above but operates as an input rail, and output rail 604 corresponds structurally to input rail 304 described above but operates as an output rail. Regulated converter stage 611 can have its input connected to input rail 603 and an output connected to tail rail 608. Regulated converter stage 611 can further produce an output voltage Vtail, which can be higher or lower than input voltage Vin, depending on the converter type used. The tail rail voltage Vtail and the input voltage Vin can be connected to the switched capacitor stages as illustrated. Switching operation may otherwise be as described above, so that in Dickson type converter 600a, the first flying capacitor 605 has a nominal voltage equal to Vtail+Vin, and the second flying capacitor 606 has a nominal voltage equal to Vtail+2Vin. Correspondingly, in series-parallel type converter 600b, both flying capacitors 605, 606 will have a nominal voltage equal to the input voltage Vin. In either converter, the output voltage Vo is equal to Vtail+2Vin.

The foregoing describes exemplary embodiments of tail regulated switched capacitor converters. Such configurations may be used in a variety of applications but may be particularly advantageous when used in conjunction with power supplies for personal electronic devices, such as smart phones, tablet computers, notebook computers, and associated accessories, such as earphones, styluses, or other peripheral devices. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A tail regulated switched capacitor converter comprising:
a plurality of switched capacitor stages each having a flying capacitor; and a plurality of switching devices, wherein:
the plurality of switching devices includes a first group of one or more switches that selectively couple the flying capacitor to one of an input or output voltage rail via a first current path and a second group of one or more switches that selectively couple the flying capacitor to a tail voltage rail via a second current path; and
the first and second groups of one or more switches are switched complementarily to one another with a 50% duty cycle; and
a regulated converter coupled to the tail voltage rail that provides voltage regulation of the output voltage rail while carrying half of a full output current of the tail regulated switched capacitor converter.

2. The tail regulated switched capacitor converter of claim 1 wherein:
the tail regulated switched capacitor converter is a step-down converter;
the first group of one or more switches selectively couples the flying capacitor to the output voltage rail via the first current path; and
the regulated converter has its input connected to the tail voltage rail and its output connected to the output voltage rail.

3. The tail regulated switched capacitor converter of claim 2 wherein the regulated converter is a buck converter.

4. The tail regulated switched capacitor converter of claim 2 wherein the regulated converter is a boost converter.

5. The tail regulated switched capacitor converter of claim 1 wherein:
the tail regulated switched capacitor converter is a step-up converter;
the first group of one or more switches selectively couples the flying capacitor to the input voltage rail via the first current path; and
the regulated converter has its input connected to the input voltage rail and its output connected to the tail voltage rail.

6. The tail regulated switched capacitor converter of claim 5 wherein the regulated converter is a buck converter.

7. The tail regulated switched capacitor converter of claim 5 wherein the regulated converter is a boost converter.

8. The tail regulated switched capacitor converter of claim 1 wherein the tail regulated switched capacitor converter is a Dickson type switched capacitor converter.

9. The tail regulated switched capacitor converter of claim 1 wherein the tail regulated switched capacitor converter is a series-parallel type switched capacitor converter.

10. A tail regulated switched capacitor converter comprising:
a plurality of switched capacitor stages each having a flying capacitor and a plurality of switching devices that selectively couple the flying capacitor to one of an input or output voltage rail via a first current path and selectively couple the flying capacitor to a tail voltage rail via a second current path; and
a regulated converter coupled to the tail voltage rail, wherein the regulated converter carries less than a full output current of the tail regulated switched capacitor converter and provides voltage regulation of the output voltage rail.

11. The tail regulated switched capacitor converter of claim 10 wherein the tail regulated switched capacitor converter is a Dickson type switched capacitor converter.

12. The tail regulated switched capacitor converter of claim 10 wherein the tail regulated switched capacitor converter is a series-parallel type switched capacitor converter.

13. The tail regulated switched capacitor converter of claim 10 further comprising an output capacitor supporting the output voltage rail and a tail output capacitor supporting the tail voltage rail.

14. The tail regulated switched capacitor converter of claim 10 wherein:
the tail regulated switched capacitor converter is a step-down converter;
the plurality of switching devices selectively couple the flying capacitor to the output voltage rail via the first current path; and
the regulated converter has its input connected to the tail voltage rail and its output connected to the output voltage rail.

15. The tail regulated switched capacitor converter of claim 10 wherein:
the tail regulated switched capacitor converter is a step-up converter;
the plurality of switching devices selectively couple the flying capacitor to the input voltage rail via the first current path; and
the regulated converter has its input connected to the input voltage rail and its output connected to the tail voltage rail.

16. The tail regulated switched capacitor converter of claim 10 wherein the regulated converter is a buck converter.

17. The tail regulated switched capacitor converter of claim 10 wherein the regulated converter is a boost converter.

18. A tail regulated switched capacitor converter comprising:
a plurality of switched capacitor stages each having a flying capacitor; and a plurality of switching devices including a first group of one or more switches that selectively couple the flying capacitor to one of an input voltage rail or an output voltage rail via a first current path and a second group of one or more switches that selectively couple the flying capacitor to the tail voltage rail via a second current path; and
a regulated converter coupled to the tail voltage rail that provides voltage regulation of the output voltage rail while carrying less than a full output current of the tail regulated switched capacitor converter.

19. The tail regulated switched capacitor converter of claim 18 wherein the plurality of switched capacitor stages includes more than two switched capacitor stages.

20. The tail regulated switched capacitor converter of claim 18 further comprising an output capacitor supporting the output voltage rail and a tail output capacitor supporting the tail voltage rail.
